(19) United States
(12) Patent Application Publication
(10) Pub. No.: US 2003/0002459 A1
(43) Pub. Date: Jan. 2, 2003

(54) Base station transceiver sub-system and frame offset allocation method thereof

(76) Inventors: Hironobu Igarashi, Kawasaki (JP); Shyota Shikano, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/968,448

(22) Filed: Oct. 1, 2001

(30) Foreign Application Priority Data
Jun. 27, 2001 (JP) 2001-194614

(51) Int. Cl. H04J 3/06

(52) U.S. Cl. 370/330; 370/350; 370/508

(57) ABSTRACT

The invention disclosed herein relates to a base station transceiver sub-system, where when data is transmitted/received via radio in predetermined time long frame units, one frame offset of a plurality of frame offsets after dividing the time length is allocated to each traffic channel, and the radio interface 50 and the ATM interface are synchronized using this frame offset. In this base station transceiver sub-system, the fluctuation of cells on an ATM line is tolerated for a predetermined frame offset width, and considering the cell transmission enabled band according to said tolerated fluctuation width, a same frame offset is allocated to a plurality of traffic channels so as to control the generation of fragmentation.

### BACKGROUND OF THE INVENTION

### 1. Field of the Invention

The present invention relates to a base station transceiver sub-system and a frame offset allocation method thereof, and more particularly to a base station transceiver sub-system and a frame offset allocation method thereof which tolerates a predetermined frame offset width of fluctuation of cells in an ATM line, and allocates a same frame offset to a plurality of traffic channels so as to control the generation of fragments.

When the base station transceiver sub-system 1 (FIG. 17) in a mobile radio communication system transmits frames to radio terminals #A2a-#C2c with a 20 ms frame as the transmission unit, one of the 16 levels of offsets with a 1.25 ms interval (hereafter frame offset) is attached to a frame for transmission. FIG. 18 is a diagram depicting transmission timing in a radio interface, where the offset of the frame FA to be transmitted to the radio terminal #A is 0 ms, the offset of the frame FB to be transmitted to the radio terminal #B is 1.25 ms, and the offset of the frame FC to be transmitted to the radio terminal #C is 2.50 ms.

When a base station controller 3, on the other hand, generates 20 ms frames and transmits them to the base station transceiver sub-system 1, the frames must be transmitted to the radio terminal with a predetermined frame offset without a delay. For this, the radio station transceiver sub-system 1 and the base station controller 3 synchronize in 20 ms units, and both know the head position of the frame (position at frame offset=0). In order to synchronize the ATM interface and the radio interface, the base station controller 3 transmits 20 ms frames on an ATM line with a delay of 1.25 ms offset. In other words, on the ATM line as well, a 1.25 ms unit offset is attached to a frame, just like the radio interface, so as to synchronize with the radio interface. For example, if offsets 0, 1 and 2 (in terms of time 0, 1.25, 2.50 ms), shown in FIG. 18, are added to the frames FA, FB and FC on the radio interface, frames (actually cells) are transmitted at the transmission timing at the same offsets 0, 1 and 2 (in terms of time 0, 1.25, 2.50 ms) even on the ATM line. FIG. 19 is a diagram depicting transmission timing on the ATM line, where frames are divided into cells and cells CL_{FA}, CL_{FB} and CL_{FC} corresponding to frames FA, FB and FC are transmitted at the transmission timing of the offsets 0, 1 and 2.

On the ATM line, the maximum number of bits that can be transmitted during one offset period is limited, but within this range of the maximum value, one frame offset can be allocated to a plurality of traffic channels. FIG. 20 is a diagram depicting transmission timing when one frame offset is allocated to a plurality of traffic channels, and shows the case when two traffic channels are allocated to offsets 0 and 2 respectively.

If cells can be transmitted with a smaller gap (unused band) in each offset, transmission efficiency can be increased and the number of users to accommodate can be increased. Therefore band management is necessary to determine how much traffic (traffic channels) is allocated to one offset.

The mobile radio system comprised of the base station transceiver sub-system 1 and the base station controller 3 shown in FIG. 17 conventionally handle voice data and low speed fixed-length data. Therefore traffic data of a predetermined traffic channel is merely transmitted mechanically in a predetermined frame offset on an ATM line where no problems occur. In other words, such problems as fluctuation and fragmentation due to the coexistence of such fixed-length data as voice data and variable length data where the data length is different, do not occur.

Generation of Fluctuation

Recently, however, users began handling such fixed-length data as voice and such variable length data as packets. In a mobile communication system using portable phones as well, the demand for such wide band data communication as packet communication is increasing. With a radio interface, high-speed communication has become possible, where the number of bits that can be transmitted in a 20 ms frame is double or, sometimes, more than ten times, compared with voice and conventional low speed data communication. In such a high-speed communication, the number of bits in a 20 ms frame which can be transmitted on an ATM line increases, and in some cases, a full 20 ms frame (transmission data of 1 traffic channel) cannot be transmitted by a 1 frame offset on an ATM line, which causes fluctuation. For example, as FIG. 21 shows, when wide band communication data D_{A}, which exceeds the 1 frame offset on the ATM line, and narrow band communication data D_{B}, such as voice, are allocated to the frame offset=0, voice delays and fluctuation occurs to voice traffic. Once fluctuation is generated, the radio interface and the ATM interface cannot be synchronized, and frames cannot be transmitted/received correctly. In the above example, if the voice is transmitted at the position of frame offset=0, the wide band data delays.

Fragmentation

Data communication involves various bit rates, from a low rate to a high rate. When data communication and low speed voice communication coexist, communication in the narrow band, such as voice and low speed data, may be distributed to each offset, as shown in FIG. 22. If such distribution is generated, fragmentation of bands increases, and a frame offset to allocate may not exist in wide band (high-speed) communication. FIG. 22 is the case when a frame offset cannot be allocated to traffic channel having a 1.5 frame band because there is no continuous empty band having a 1.5 frame band. However, as shown in FIG. 23, if the traffic channels in the narrow band concentrate to the frame offset=0, and fragmentation decreases, then frame offset=1 and 2 have empties, and a traffic channel in the wide band can be allocated to the frame offset=1 for transmission.

### SUMMARY OF THE INVENTION

With the foregoing in view, it is an object of the present invention to absorb fluctuation so as to transmit/receive data correctly.

It is another object of the present invention to control the generation of fragments of bands while absorbing fluctuation.

It is still another object of the present invention to allocate a traffic channel, which is allocated to each frame offset, while managing bands.

A first aspect of the present invention is a base station transceiver sub-system which transmits/receives data to/from a mobile station via radio, and transmits/receives data in cells to/from a base station controller via a transmission line, comprising: (1) an offset allocation block which allocates one frame offset of a plurality of frame offsets after dividing a predetermined time length to each traffic channel when data is transmitted/received via radio in the predetermined time long frame units; (2) a radio interface which transmits frames of a predetermined traffic channel at timing according to the frame offset allocated to the traffic channel; (3) a transmission line interface block which divides the frame of each traffic channel into cells and transmits/receives the cells to/from the base station controller via the transmission line at timing according to the frame offset allocated to the traffic channel; and (4) a fluctuation tolerance block which tolerates the fluctuation of the cells on the transmission line for a predetermined frame offset width, wherein the offset allocation block allocates a same frame offset to a plurality of traffic channels considering a data transmission enabled band according to the tolerated fluctuation width.

The fluctuation tolerance block further comprises: a memory for storing frames for a period according to the fluctuation width, and a fluctuation control block which reads frames from the memory and inputs the frames into a modulation block at a predetermined timing. The offset allocation block sets the band management range considering the tolerated fluctuation width as the data transmission enabled band corresponding to each one of the plurality of frame offsets, and allocates each frame offset to a plurality of traffic channels so as not to exceed the band management range.

A second aspect of the present invention is a frame offset allocation method for a base station transceiver sub-system, comprising an offset allocation block, a radio interface, and a transmission line interface, comprising steps of: (1) tolerating the fluctuation of frames on the transmission line for a predetermined frame offset width; and (2) allocating a same frame offset to a plurality of traffic channels considering the data transmission enabled band according to the tolerated fluctuation width. When a traffic channel is allocated, a band management range is set according to the tolerated fluctuation width corresponding to each one of the plurality of frame offsets, and each frame offset is allocated to a plurality of traffic channels so as not to exceed the band management range.

According to the present invention, frame synchronization between the radio interface and the ATM interface can be guaranteed by absorbing fluctuation and the frames can be transmitted/received correctly. Also the fragmentation of a band can be controlled while absorbing fluctuation, traffic channels can be allocated in a wide band, and the band can be used effectively. Also 1 frame offset can be allocated to a plurality of traffic channels while managing the band of a traffic channel to be allocated to each frame offset, and the band can be used effectively.

Other features and advantages of the present invention will be apparent from the following descriptions with reference to the accompanying drawings.

### BRIEF DESCRIPTION OF THE DRAWINGS

FIG. 1A, FIG. 1B and FIG. 1C are diagrams depicting frame offsets;

FIG. 2 is a diagram depicting the decision of an offset considering fluctuation;

FIG. 3 is a diagram depicting frame offset allocation when fluctuation is tolerated on an ATM line;

FIG. 4A, FIG. 4B, FIG. 4C and FIG. 4D are diagrams depicting frame offset allocation considering the tolerated fluctuation range;

FIG. 5 is a diagram depicting traffic channel allocation when available bands in the band management range have decreased;

FIG. 6 is a diagram depicting the state after traffic channel allocation when available bands in the band management range have decreased;

FIG. 7 is a block diagram depicting a base station transceiver sub-system and a base station controller;

FIG. 8 is a diagram depicting the protocol structure between BSC and BTC;

FIG. 9 is a diagram depicting the format of an AAL-type 2 cell;

FIG. 10 is a diagram depicting the format of an AAL-type 2 cell and a short cell;

FIG. 11 is a diagram depicting the concept of the transfer system by AAL-type 2;

FIG. 12 is a block diagram depicting a base band processing block;

FIG. 13 is a diagram depicting a resource management table;

FIG. 14 shows an allocation processing flow of a traffic channel;

FIG. 15 shows a processing flow when a channel is disconnected;

FIG. 16 shows a fluctuation absorption processing flow;

FIG. 17 is a diagram depicting a mobile communication system;

FIG. 18 is a diagram depicting transmission timing in a radio interface;

FIG. 19 is a diagram depicting transmission timing on an ATM line;

FIG. 20 is a diagram depicting transmission timing when 1 frame offset is allocated to a plurality of channels;

FIG. 21 is a diagram depicting fluctuation which is generated on an ATM line;

FIG. 22 is a diagram depicting the fragmentation of a band on an ATM line; and

FIG. 23 is a diagram depicting the case when the fragmentation of a band is minor.

### DESCRIPTION OF THE PREFERRED EMBODIMENTS

(A) Overview of the Present Invention

(a) Frame Offset

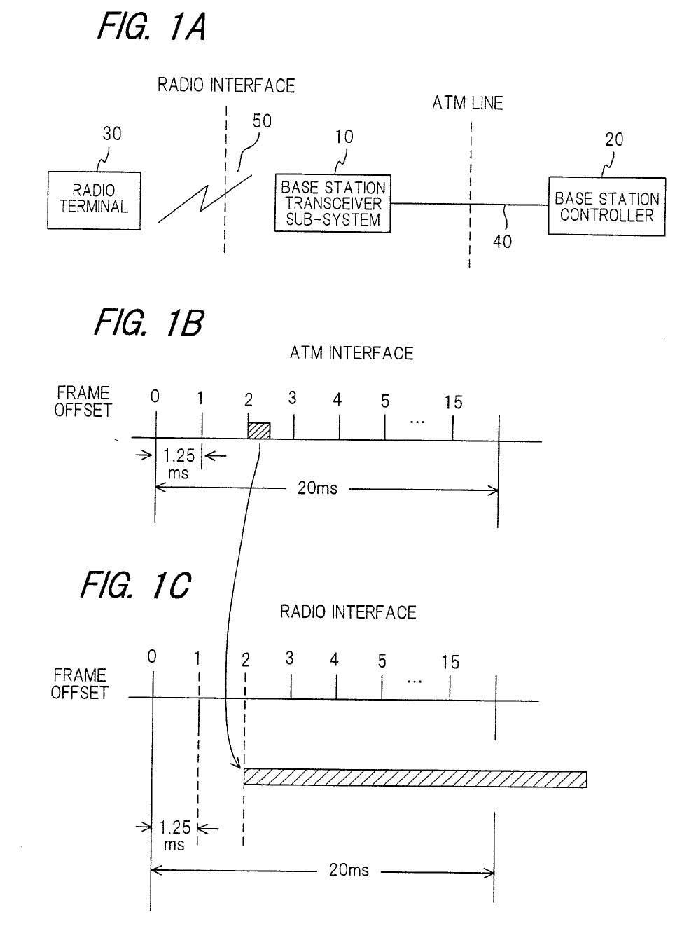

A mobile radio communication system comprises a base station transceiver sub-system (BTS) 10 and a base station controller (BSC) 20 which are inter-connected via an ATM line, as shown in FIG. 1A. The base station transceiver sub-system 10 receives 20 ms frames (actually cells) per channel from the base station controller 20 via the ATM line 40, and transmits the 20 ms frames to a mobile station 30 via a radio interface 50. Both the base station transceiver sub-system 10 and the base station controller 20 use a 20 ms frame as the transmission unit, adds one of the 16 levels of offset with a 1.25 ms interval to a frame, and transmits the frame, as shown in FIG. 1B.

The base station transceiver sub-system 10 and the base station controller 20 synchronize in 20 ms units, and both know the head position of the frame (position of frame offset=0). To transmit 20 ms frames (cells) of a predetermined traffic channel, the base station controller 20 transmits the frames (cells) at transmission timing according to the frame offset allocated to the traffic channel (frame offset=2 in the case of FIG. 1B), and the base station transceiver sub-system 10 adds as the frame offset according to the traffic channel (frame offset=2 in this case) to the frames, and transmits it to the mobile terminal 30 via the radio interface 50, as shown in FIG. 1C. Actually, the base station transceiver sub-system 10 employs a means (mentioned later) of tolerating delay for the total M frame offset width considering transmission delay on the transmission line, processing delay and fluctuation of phases of cells. Therefore a time delay corresponding to the M frame offset is tolerated between the frame offset n on the ATM line and the frame offset n on the radio interface.

When frames of a predetermined traffic channel are received from the mobile station 30, the base station transceiver sub-system 10 packetizes the frames into cells, and transmits the cells to the base station controller 20 via the ATM line 40 according to the traffic channel.

(b) Absorption of Fluctuation

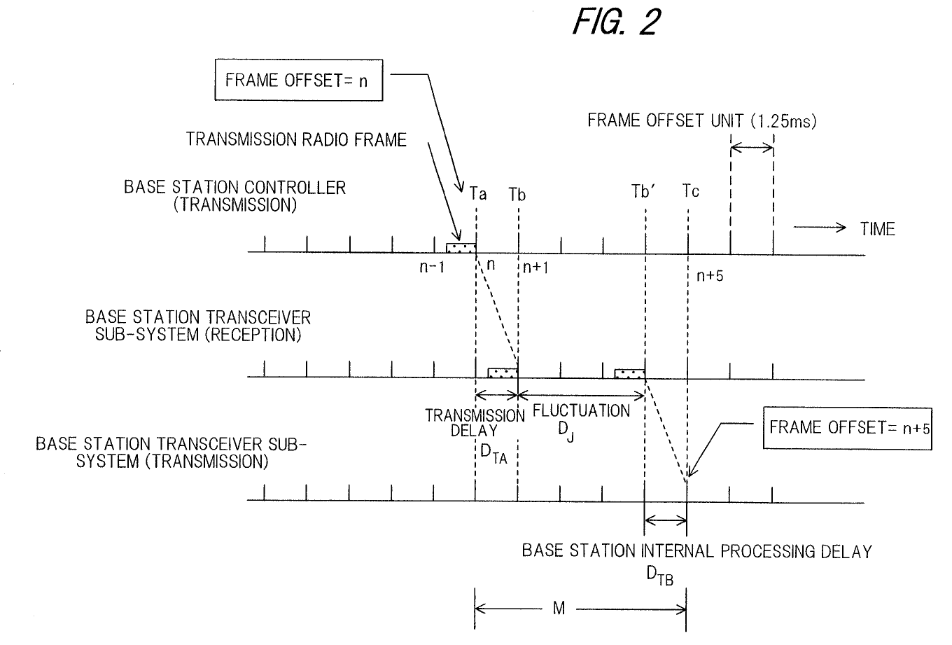

FIG. 2 is a diagram depicting how to decide the offset considering delay (fluctuation).

To determine a frame offset position on an ATM line, the transmission delay D_{TA} (=Ta−Tb) on an ATM line and the internal processing delay D_{TB} (=Tb′−Tc) of the base station transceiver sub-system 10 from receiving 20 ms frames from the base station controller 20 to transmitting the 20 ms frames to the radio interface 50, must be considered. In addition to these delays, the present invention decides the frame offset considering fluctuation. In the example in FIG. 2, the fluctuation tolerance range for the total M (=5) frame offset width is set considering 1 frame offset as the transmission delay D_{TA} of the ATM line, 1 frame offset as the base station internal processing delay D_{TB}, and 3 frame offsets as the fluctuation absorption range D_{J}. This tolerated fluctuation range can be set by storing frames (traffic data) in a memory for the period according to this range, and reading the frames from this memory at a predetermined timing. By setting the tolerated fluctuation range, a margin for the time delay corresponding to the M frame offset is generated between the frame offset n on the ATM line and the frame offset n on the radio interface.

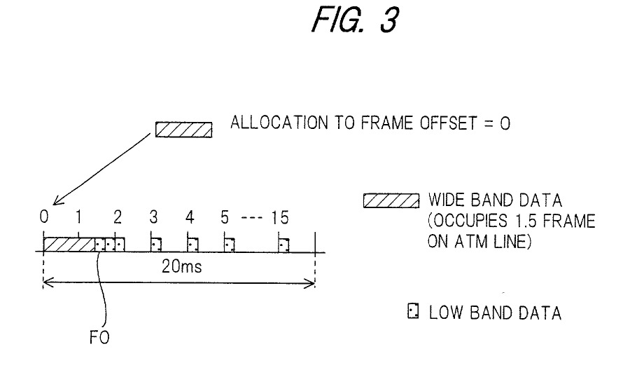

The effect of the tolerated fluctuation range will now be described with reference to FIG. 3. It is assumed that a traffic channel of wide band data (for a 1.5 frame offset) is allocated to the frame offset=0. By this, fluctuation is generated at the narrow band frame F0 which exists at the frame offset=0, and frame F0 fluctuates to the frame offset=1. However, the tolerated fluctuation range is up to a 5 frame offset, so the base station transceiver sub-system 10 can transmit this frame F0 at the radio frame offset=0 without delay.

(c) Controlling Fragmentation

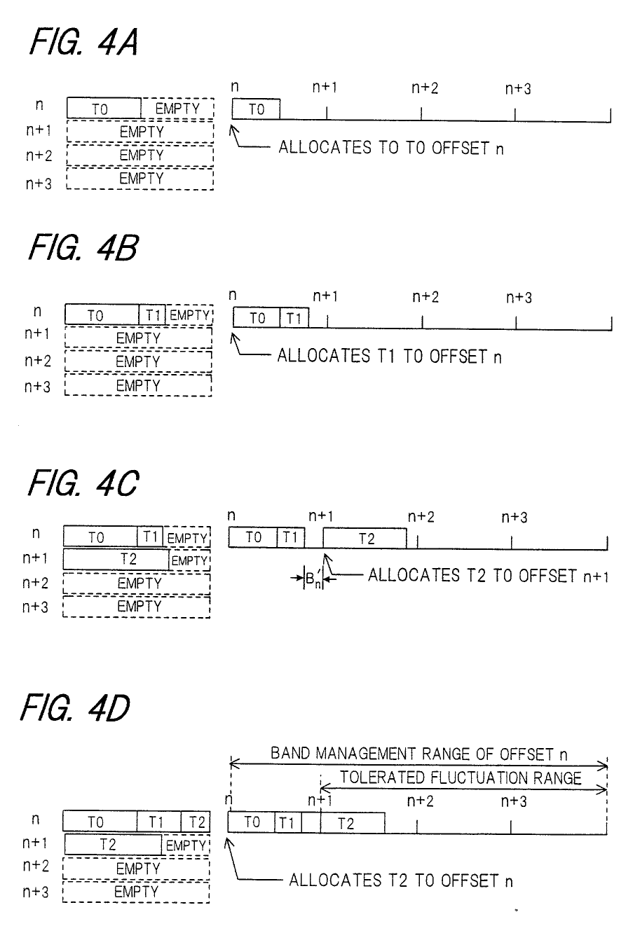

In the present invention, band management to control the generation of fragmentation is performed based on the fact that fluctuation for up to M frame offsets is tolerated by setting the tolerated fluctuation range. FIG. 4(A) is a state where the traffic channel T0 is allocated to the frame offset=n, and FIG. 4(B) is a state where the traffic channel T1 is also allocated to the frame offset=n. This is because there is sufficient remaining available band at the frame offset=n with respect to the band of the traffic channel T1. Then the band for the traffic channel T2 is secured.

FIG. 4(C) is an example of conventional offset allocation where the generation of fluctuation is not tolerated. In the frame offset=n, there is no empty to secure a band required for the traffic channel T2. Therefore the traffic channel T2 is allocated to the frame offset n+1. With such an allocation, however, some band Bn′ of the frame offset=n which is not used remains as a fragment. This fragment is used if a traffic channel whose band is smaller than the band Bm′ is generated in the feature, but remains otherwise. If such a status is generated at each frame offset position and many fragments are generated, a continuous empty band required for securing the band of the traffic channel for which connection is requested does not exist, even though a sufficient empty band exists on the total ATM line, and the connection of this traffic channel is impossible.

So in the present invention, the traffic channel is allocated to a frame offset considering the tolerated fluctuation range. In the example in FIG. 4(D), the tolerated fluctuation range is the length of the M (=3) offset. By setting the tolerated fluctuation range, the band width of the frame offset n is regarded as 4 offsets, including the tolerated fluctuation. In other words, the band management range of the offset n is 4 offsets, from n to n+3, where a plurality of traffic channels can be allocated to the frame offset n within a range which does not exceed the band width of this band management range. This is because fluctuation is controlled within the tolerated fluctuation range, even if the traffic of a predetermined traffic channel fluctuates up to the n+3 offset by allocating a plurality of traffic channels to the frame offset n, and the frame is delivered by allocating a plurality of traffic channels to the frame offset n, before the frame offset n on the radio interface. The frame offset n on the radio interface is actually delayed 3 offsets from the frame offset n on the ATM interface.

Therefore the traffic channel T2 can be allocated to the offset n, as shown in FIG. 4(D). In this case, the traffic channel T2 uses a band up to n+1, exceeding the offset position n, but is still within the tolerated fluctuation range. So the base station transceiver sub-system 10 can receive the traffic data of the traffic channel T2 before the radio frame offset n, performs spread modulation on the traffic data, and transmits the spread data. The emptyband in the offset n does not fragment and remains, and the band can be used efficiently.

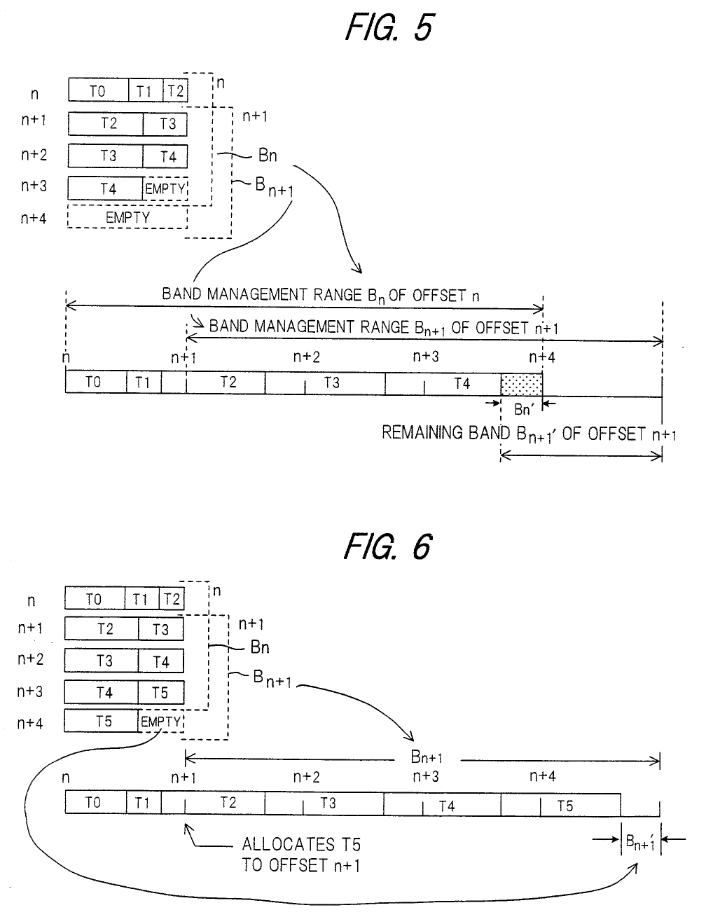

FIG. 5 is a traffic channel allocation example when the remaining available band Bn′, which can be used within the band management range Bn of the offset n, is decreased. Although the traffic channel T5 attempts allocation to the offset n, the empty band Bn′ at the n+3 position in the band management range Bn of the offset n is insufficient for allocating the traffic T5. In this case, the offset is shifted to n+1, and it is checked whether the band management range Bn+1 of the offset (n+1) has sufficient empty. Considering the tolerated fluctuation range (3 offsets in this example), the band Bn+1′, which is the total of what remains of n+3 and n+4, is empty. Therefore the traffic channel T5 can be allocated to the offset n+1. FIG. 6 shows this state. Since the traffic T0-T4 allocated to the offset n substantially uses the band of the offset n+3, the transmission of T5 ends at the position n+4, but is still within the tolerated fluctuation range Bn+1 of the frame offset (n+1). Therefore the base station transceiver sub-system 10 can receive the frames of the traffic channel T5 from the ATM line before the radio frame offset n+1, and modulates and transmits the frames.

(B) Configuration of Base Station Transceiver Sub-system and Base Station Controller

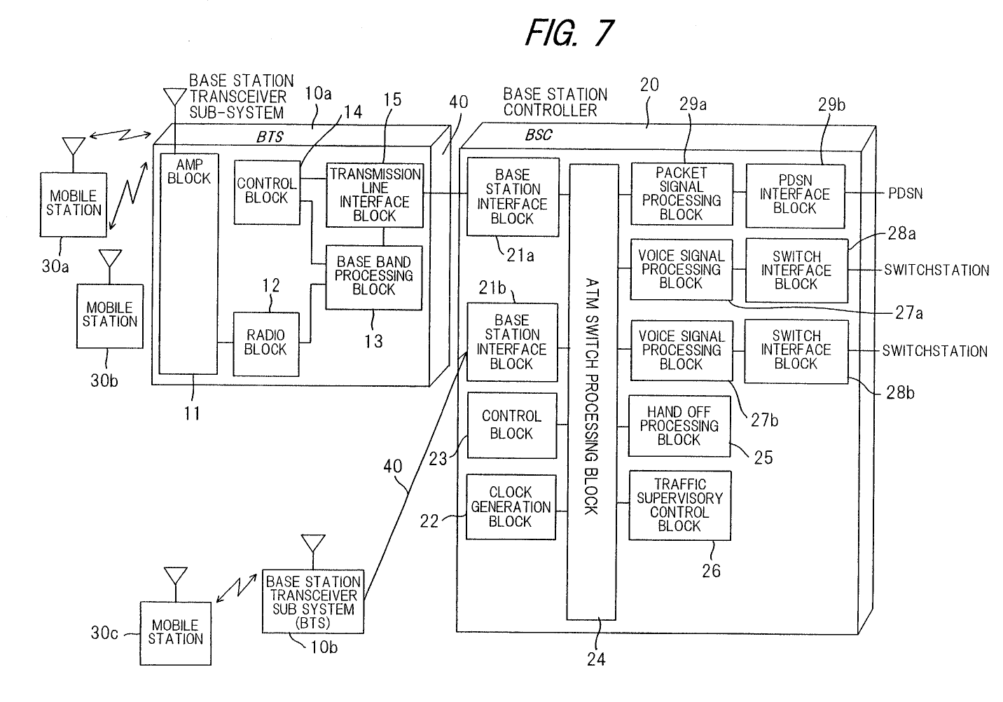

FIG. 7 is a block diagram of a base station transceiver sub-system and a base station controller, where 10a-10b are the base station transceiver sub-systems (BTS), 20 is a base station controller (BSC) which controls a plurality of base stations (BTS), and 30a-30c are mobile stations which exist in radio zones corresponding to the base stations 10a and 10b, and communicate with the corresponding base stations via radio. The base station transceiver sub-systems (BTS) 10a-10b and the base station controller (BSC) 20 are connected by the ATM line 40, and the base station transceiver sub-system 10a-10b receive 20 ms frames (actually cells) from the base station controller 20 via the ATM line, and transmits the 20 ms frames to the mobile station via the radio interface.

The base station transceiver sub-systems 10a and 10b have the same configuration, comprising: an AMP block 11, a radio block 12, a base band signal processing block 13 which performs base band signal processing, a controller 14 in the base station transceiver sub-system which controls channel allocation and power management, and the transmission line interface block 15. The amplifier block 11 amplifies the transmission/reception signal, and the radio block 12 converts the frequencies of high frequency signals, which are input from the antenna via the amplifier block, to a base band signal, and converts base band signals to high frequency signals and inputs the high frequency signals to the antenna via the amplifier block. The base band signal processing block 13 performs such processing as spread and orthogonal modulation on a plurality of channels of communication signals (various control signals, voice signals, data signals, etc.), inputs the modulated signals to the radio block 12, and performs such processing as orthogonal detection, inverse spread and data demodulation on a plurality of channels of communication signals, which are input from the radio block 12, and inputs the demodulated data to the transmission line interface block 15 and the control block 14. The transmission line interface block 15 performs N channels of signal multiplex and signal demultiplex processing, and performs signal conversion processing between the base station transceiver sub-system (BTS)/base station controller (BSC). The controller 14 in the station performs call control and transmission power management control, and performs traffic channel setup control related to the present invention.

The base station controller 20 comprises base station interface blocks 21a and 21b, a clock generation block 22, a control block 23, an ATM switch/processing block 24, a hand off processing block 25, a traffic supervisory control block 26, voice signal processing blocks 27a and 27b, switch interface blocks 28a and 28b, a packet signal processing block 29a, and a PDSN interface block 29b. The base station interface blocks 21a and 21b perform signal format conversion and level conversion between the base station transceiver sub-systems 10a and 10b and the switches, and the clock generation block 22 generates reference clocks and various timing signals. The control block 23 controls the base station controller in general, and the ATM switch/processing block 24 transmits signals from each base station transceiver sub-system 10a and 10b to a predetermined port at the switch station side, and transmits signals from the switch station side to a predetermined base station transceiver sub-system. The hand off processing block 25 performs hand off control, the traffic supervisory control block 26 supervises the traffic channel (traffic) for each base station transceiver sub-system, the voice signal processing blocks 27a and 27b performs conversion between the voice encoding system of radio zones (between a terminal and base station controller) and the voice encoding system (PCM) of a public network, and the switch interface blocks 28a and 28b performs signal conversion processing between the base station controller and the switch station. The packet signal processing block 29a performs packet signal processing.

(C) Frame Format

(a) Protocol Structure

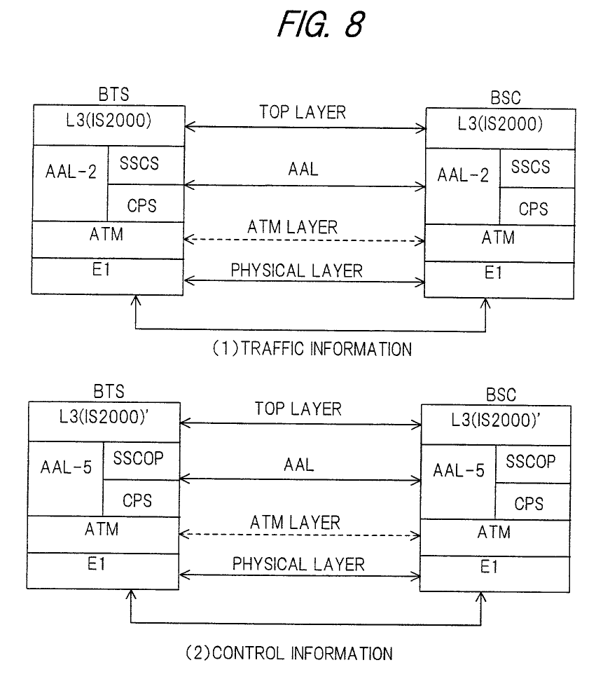

FIG. 8 is a diagram depicting a protocol structure between BSC and BTS where E1 is used for the physical layer, the ATM layer is on the physical layer, the AAL layer is thereon, and the application layer is on top. The AAL layer uses AAL-type 2 for transferring traffic information, and uses AAL-type 5 for transferring control information, as shown in (1) and (2).

In the field of mobile communication, data is converted to a low bit rate data format by compression in order to use the communication band effectively. When such low speed bit rate information is embedded into a payload of a standard ATM cell, it takes time for the payload of one ATM cell to be filled with data. This delays data and tends to drop the quality of communication. So, as a method to transmit low bit rate information with less delay, a multiple transfer system called AAL-type 2 is recommended in ITU-T I.363.2. This transfer method, AAL-type 2, is suitable for transferring low bit rate information used for mobile communication networks, and can use a band effectively with few delays.

(b) AAL-type 2 Format

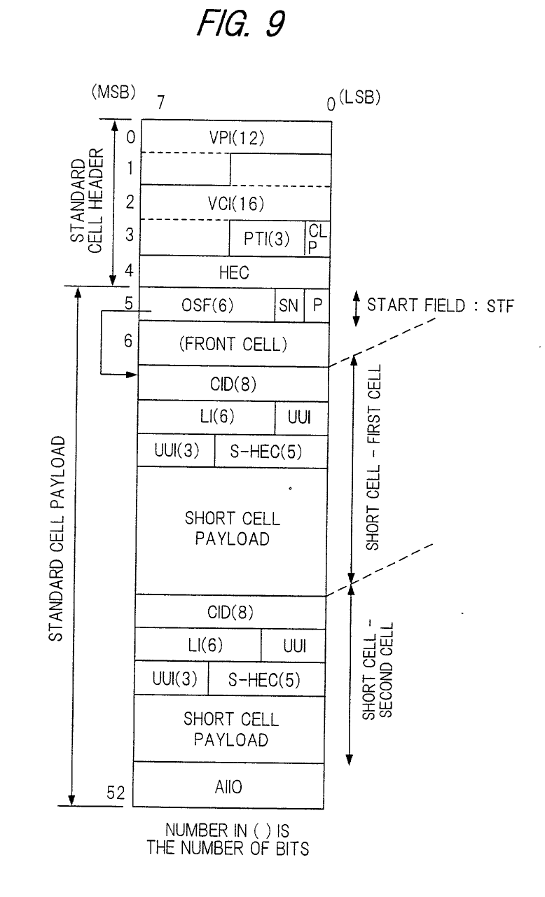

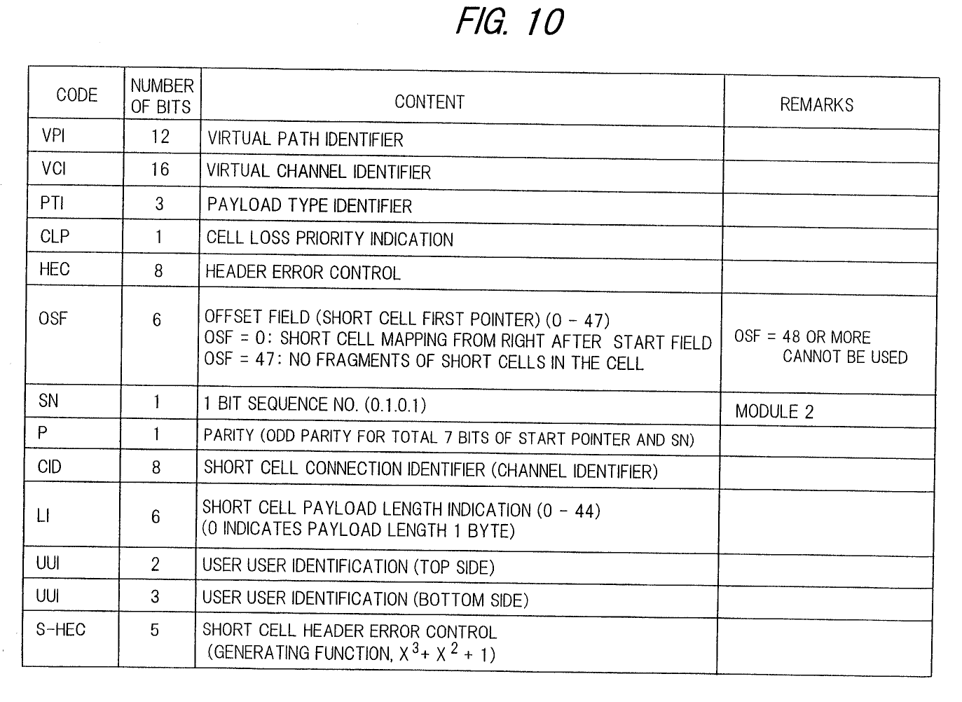

FIG. 9 and FIG. 10 are diagrams depicting the format of AAL-type 2. FIG. 11 is a diagram depicting the concept of a transfer system based on AAL-type 2. As FIG. 9 shows, an ATM cell in AAL-type 2 format is comprised of a standard cell header and a standard cell payload, where a 1 byte start field STF and 1 or more short cells are mapped in the standard cell payload.

The start field STF is comprised of (1) an offset field OFS where the pointer to indicate the first position of the first short cell (offset value) is stored, (2) a field SN where a 1 bit sequence number is stored, and (3) a parity field P.

A short cell is created for each traffic channel, and is comprised of (1) a fixed-length short cell header and (2) a variable length short cell payload. The short cell header includes \mathring{1} a short cell connection identifier (channel identifier) CID for identifying the short cell connection (traffic channel), \mathring{2} a length indicator (LI) for indicating the payload length of the short cell, and \mathring{3} a user user identifier (UUI), and the short cell payload includes low bit rate traffic information.

In the AAL-type 2 cell, a plurality of short cells are stored in a multiplexed state. If a part of the short cells exceed the payload of one AAL-type 2 cell, the remaining part of the short cells are mapped to the next AAL-type 2 cell, as shown in FIG. 11 (overlap). And the AAL-type 2 cell is transmitted on a predetermined ATM connection according to the VPI/VCI stored in the header.

(D) Configuration of Base Station Transceiver Sub-system

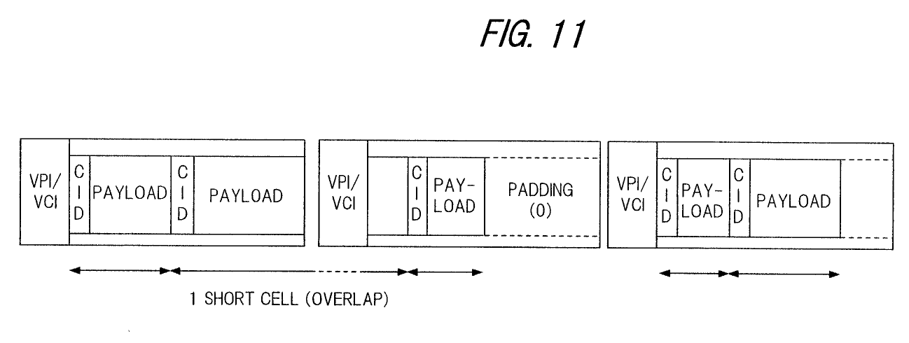

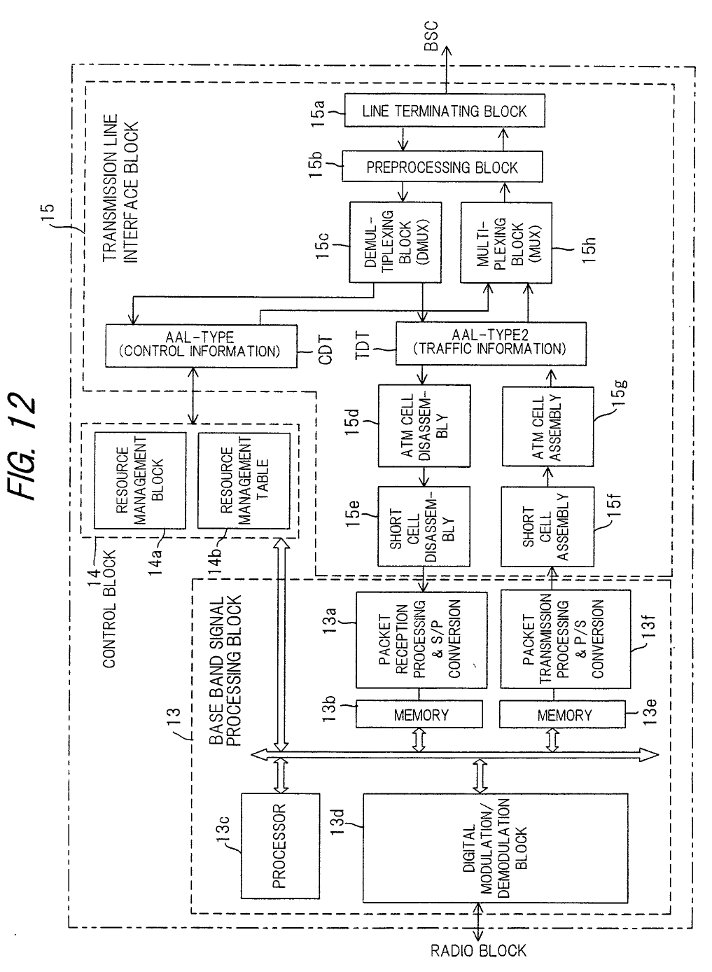

FIG. 12 is a block diagram depicting a part of the base station transceiver sub-system.

In the transmission line interface block 15, the line terminating block 15a perform E1 interface termination processing, and the preprocessing block 15b extracts cells from the received frame at reception, and performs synchronization processing using HEC. The demultiplexing block (DMUX) 15c demultiplexes the traffic information TDT of AAL-type 2, and control information CDT of AAL-type 5 and outputs this information.

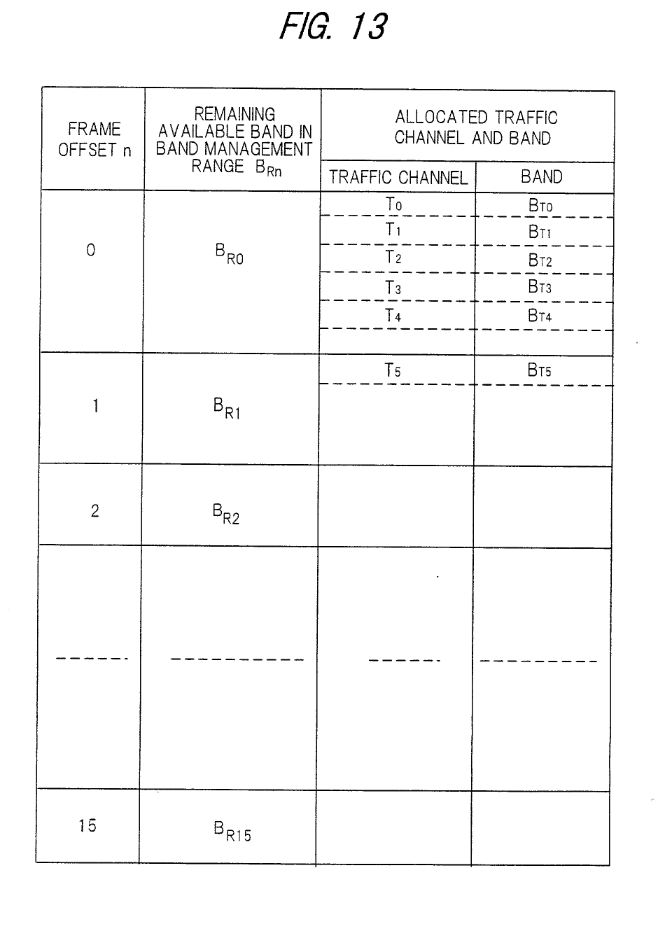

The control block 14 performs a predetermined control processing based on the control information. For example, the resource management block 14a performs allocation processing to allocate traffic channels to frame offsets when a traffic channel setup request is received from the base station controller 20, and also performs allocation release processing when a traffic channel release request is received. The allocation result is stored in the resource management table 14b, so that the later mentioned processor 13c can use it. FIG. 13 is a block diagram of the resource management table, where \mathring{1} the remaining available band B_{Rn} in the band management range and \mathring{2} the identifier of the allocated traffic channel and the band thereof are stored corresponding to the frame offset n=0-15.

The ATM cell demultiplexing block 15d demultiplexes the ATM cell into AAL-type 2 cells (short cells) and the short cell demultiplexing block 15e demultiplexes short packets (traffic information) from the short cells, and inputs the packets to the packet reception processing & S/P conversion block 13a. The packet reception processing & S/P conversion block 13a performs a CRC check and an HEC check, performs serial/parallel conversion, and stores parallel data in the memory 13b. The processor 13c reads the frames (traffic data) of one or more traffic channels allocated to the target frame offset n from the memory 13b at a predetermined timing, considering the tolerated fluctuation range for each frame offset n (n=0-15), inputs the traffic data of each channel which was read to the spread modulation block according to the traffic channel of the digital modulation/demodulation block 13d, and transmits the spread modulated data via the radio block.

The processor 13c stores data which was demodulated by the inverse spread demodulation block of each channel in the digital modulation/demodulation block 13d in the memory 13e. The packet transmission processing block & P/S conversion block 13f reads the data from the memory 13e, performs HEC insertion and CRC insertion processing and parallel/serial conversion, and inputs the serial data to the short cell assembly block 15f. The short cell assembly block 15f assembles AAL-type 2 cells (short cells), and the ATM cell assembly block 15g assembles ATM cells from the short cells, and inputs the ATM cells to the multiplexing block 15h. The multiplexing block 15h multiplexes the traffic information of AAL-type 2 and the control information of AAL-type 5, and inputs the multiplexed information to the preprocessing block 15b, and the preprocessing block 15b calculates and inserts HEC into multiplexed information at transmission, and inputs the information to the line terminating block 15a. The line terminating block 15a directly maps the multiplexed ATM cells to the E1 frame.

(E) Allocation Processing

(a) Traffic Channel Allocation Processing

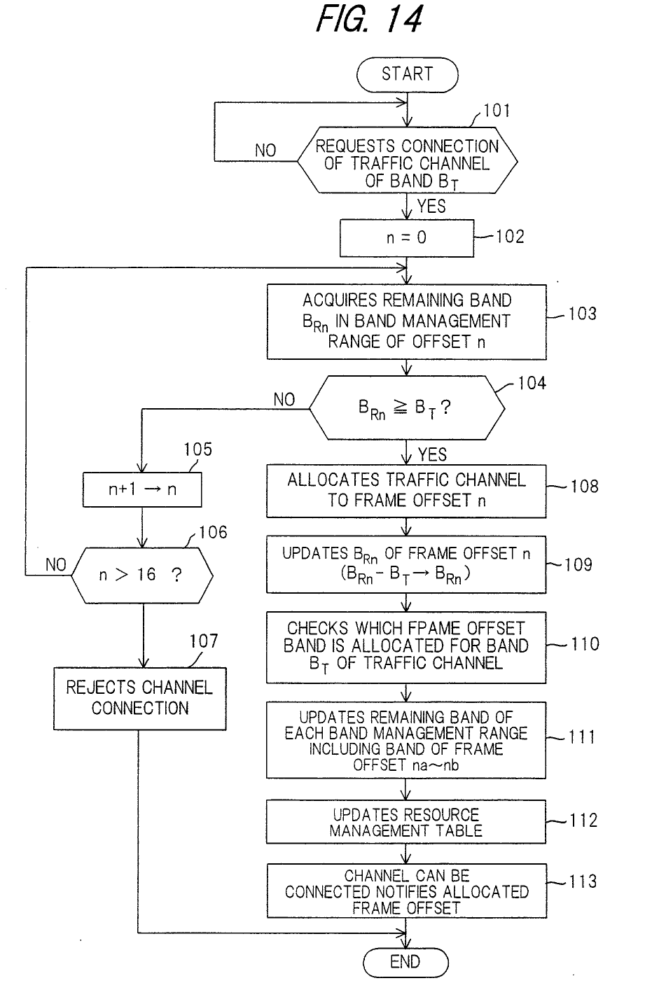

FIG. 14 depicts a traffic channel allocation processing flow by the resource management block 14a.

When a traffic channel connection request is detected (Step 101), the resource management block 14a sets n=0 (Step 102), and acquires the remaining available band B_{Rn} in the band management range of offset n from the resource management table 14b (Step 103).

Then the resource management block 14a checks whether the remaining available band B_{Rn} is greater than the traffic transmission band B_{T} of the traffic channel for which connection is requested (Step 104), and if smaller, n is changed (n+1→n, Step 105), n>16 is checked (Step 106), and if n is smaller than 16, processing after Step 103 is repeated. However, if n>16 in Step 106, the resource management block 14a regards this as allocation disabled, and returns a resource securing disabled response (channel connection disabled) to the channel connection request source (Step 107).

If B_{Rn}≧B_{T} in Step 104, the requested traffic channel is allocated to the frame offset n (Step 108). Then the remaining available band B_{Rn} in the frame offset n is updated by the following formula.

B_{Rn}−B_{T}→B_{R} (Step 109)

Then the resource management block 14a checks which frame offset and how many bands will be allocated for the band B_{T} of the traffic channel (Step 110). Here the bands Bₙₐ˜B_{nb} of the frame offsets na˜nb are allocated to the traffic channel respectively.

Then a plurality of frame offsets where at least one of the frame offsets na˜nb is included in the band management range are determined, and the remaining available bands of each frame offset is updated based on the allocated band Bna˜Bnb (Step 111).

Then the resource management block 14a updates the content of the resource management table 14b (Step 112), and notifies the channel connection request source that the channel connection is possible and information on the allocated frame offsets (Step 113).

By this, the base station controller 20 packs the frames (short cells) of each traffic channel into ATM cells, and transmits the ATM cells at the notified timing of the frame offset. Referring to the resource management table 14b, the processor 13c identifies one or more traffic channels allocated to the target frame offset n, and reads the traffic data of this traffic channel from the memory 13b at a predetermined timing considering the tolerated fluctuation range, and inputs the traffic data to the digital modulation/demodulation block 13d.

(b) Allocation Processing when Traffic Channel is Disconnected

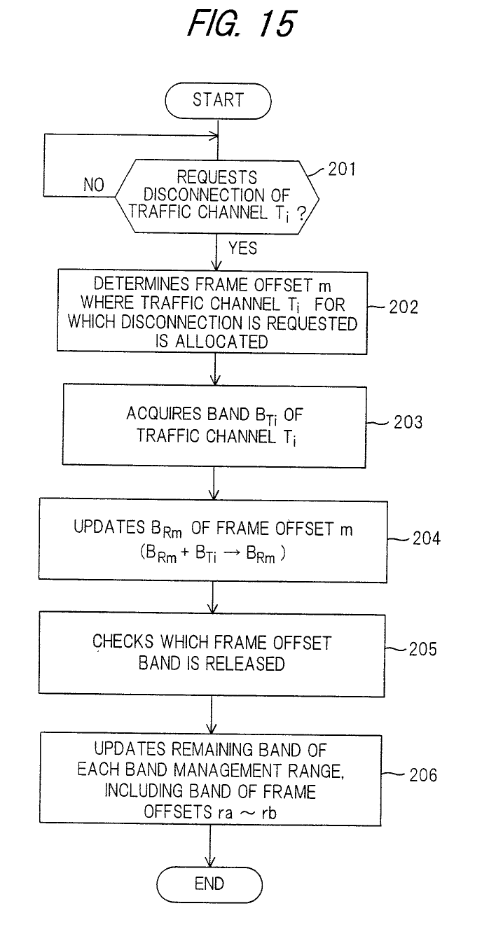

FIG. 15 depicts the allocation processing flow by the resource management block 14a when a traffic channel is disconnected. When a traffic channel disconnection request is detected (Step 201), the resource management block 14a determines a frame offset m where the traffic channel Ti, for which disconnection is requested, is allocated, referring to the resource management table 14b (Step 202). Then the resource management block 14a acquires the remaining available band B_{Rm} of the frame offset m and the band B_{Ti} of the traffic channel Ti from the resource management table 14b (Step 203), and updates the remaining available band B_{Rm} of the frame offset m by the following formula.

B_{Rm}−B_{Ti}→B_{Rm} (Step 204)

Then the resource management block 14a checks which frame offset and how many bands will be released (Step 205). Here the bands Bra˜Brb of the frame offsets ra˜rb are released respectively.

Then a plurality of frame offsets where at least one of the frame offsets ra˜rb is included in the band management range are determined, and the remaining available bands of each frame offset are updated based on the bands Bra˜Brb which are released (Step 206).

(F) Fluctuation Absorption Processing

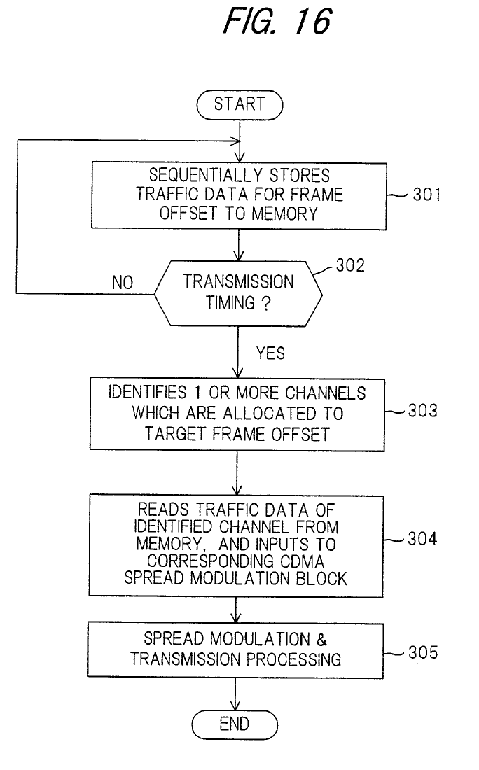

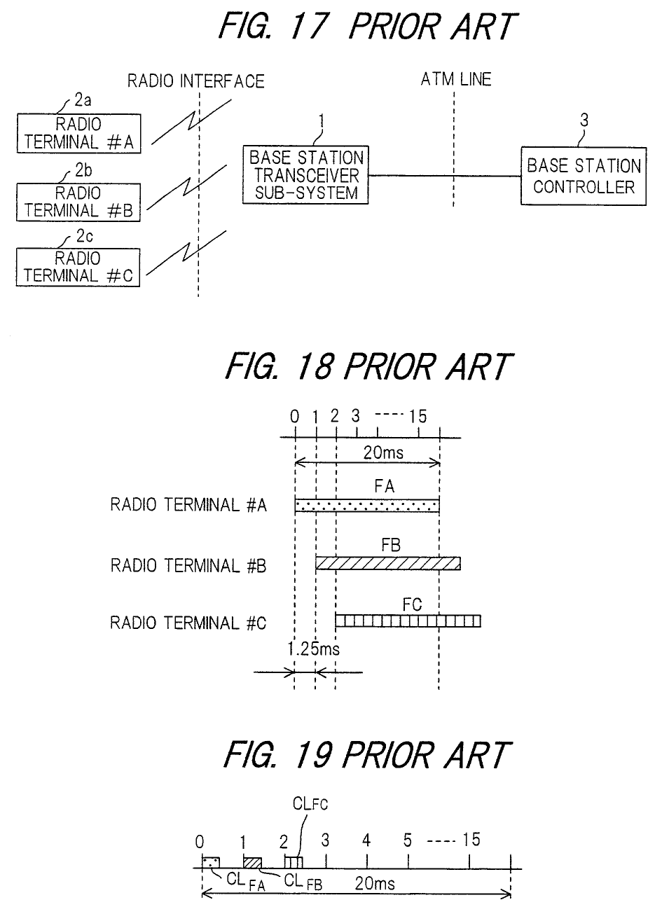

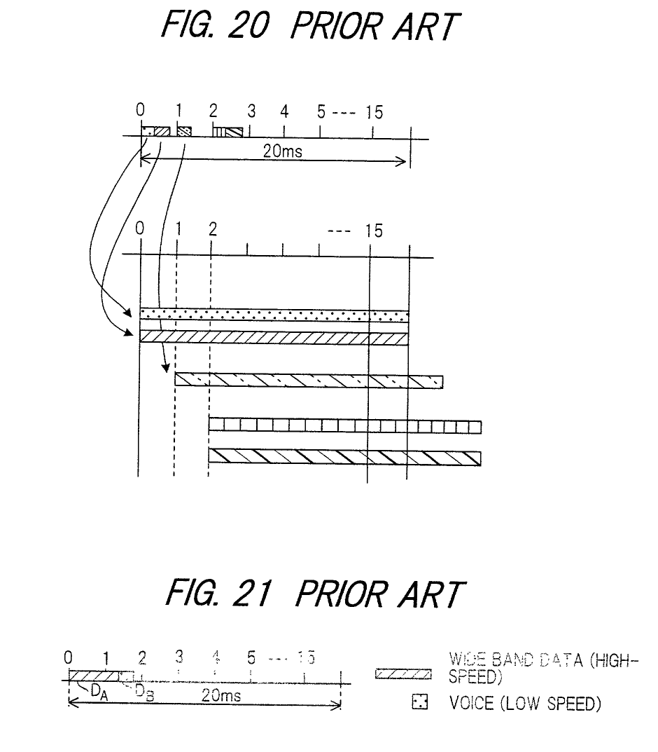

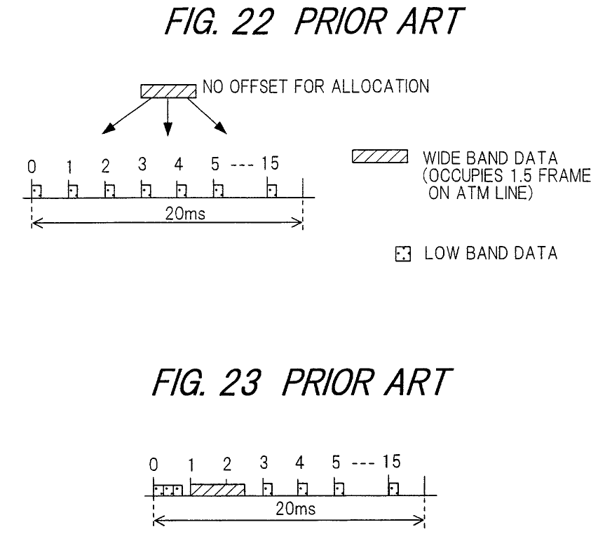

FIG. 16 shows a flow of fluctuation absorption processing.

If the tolerated fluctuation range is the M frame offset, then the traffic data (short cell data) for at least the M frame offset is sequentially stored in the memory 13b (FIG. 12) (Step 301), and it is monitored whether the transmission timing at the target offset frame n has been reached. When the transmission timing at the target offset frame n has been reached, the traffic channel allocated to this target offset frame is identified referring to the resource management table 14b (Step 303), the traffic data of this identified traffic channel is read from the memory 13b, and is input to the corresponding CDMA spread modulation block (Step 304). By this, each spread modulation block performs spread modulation, and transmits the transmission data via the radio interface (Step 305).

Then the target frame offset n is changed, and the processing after Step 301 is repeated.

In the above description, a case when allocation processing is performed by the control block 14 was described, but the allocation processing can also be performed by the processor 13c.

According to the present invention, frame synchronization between the radio interface and the ATM interface can be secured by absorbing fluctuation, so frames can be correctly transmitted/received.

Also according to the present invention, the generation of fragmentation of bands can be controlled while absorbing fluctuation, so that traffic channel allocation in a wide band is possible, and bands can be used effectively.

Also according to the present invention, a plurality of traffic channels can be allocated to one frame offset while managing the band of traffic channels to be allocated to each frame offset, which allows effective use of a band.

As many apparently widely different embodiments of the present invention can be made without departing from the spirit and scope thereof, it is to be understood that the invention is not limited to the specific embodiments thereof except as defined in the appended claims.

What is claimed is:

1. A base station transceiver sub-system which transmits/receives data to/from a mobile station via radio, and transmits/receives data in cells to/from a base station controller via a transmission line, comprising:
an offset allocation block which allocates to each traffic channel one of a plurality of frame offsets generated by dividing a predetermined time length when data is transmitted via radio in said predetermined time length frame units;
a radio interface which transmits frames of a predetermined traffic channel at timing according to the frame offset allocated to said traffic channel;
a transmission line interface which assembles cells using frame of each traffic channel and transmits/receives the cells to/from the base station controller via the transmission line at timing according to the frame offset allocated to said traffic channel; and
a fluctuation tolerance block which tolerates the fluctuation of a cell on the transmission line for a predetermined frame offset width,
wherein said offset allocation block allocates a same frame offset to a plurality of traffic channels considering the data transmission band determined by said tolerated fluctuation width.

2. The base station transceiver sub-system according to claim 1, wherein said fluctuation tolerance block further comprises:
a memory for storing frames for a period according to said fluctuation width; and
a fluctuation control block which reads frames from said memory and inputs the frames into a modulation block at a predetermined timing.

3. The base station transceiver sub-system according to claim 1, wherein said offset allocation block sets a band management range, considering said tolerated fluctuation width, as said data transmission band, corresponding to each one of the plurality of frame offsets, and allocates each frame offset to a plurality of traffic channels so as not to exceed said band management range.

4. The base station transceiver sub-system according to claim 3, wherein said band management range of a predetermined frame offset is determined by a total width where the period of said frame offset and the tolerated fluctuation width are added.

5. The base station transceiver sub-system according to claim 3, wherein it is checked sequentially whether the remaining data transmission band in the band management range of each fame offset is greater than the required band of the traffic channel, and if greater, the frame offset according to said band management range is allocated to said traffic channel.

6. The base station transceiver sub-system according to claim 5, wherein when said frame offset is allocated to the traffic channel, the remaining data transmission band of the band management range according to said frame offset is decreased, and the remaining data transmission band of the band management range of another frame offset which will be influenced by the allocation of said traffic channel is decreased.

7. The base station transceiver sub-system according to claim 5, wherein when a traffic channel is disconnected, the remaining data transmission band of the band management range according to a frame offset which is allocated to said traffic channel is increased, and the remaining data transmission band of the band management range of another frame offset which will be influenced by disconnection of said traffic channel is increased.

8. A frame offset allocation method for a base station transceiver sub-system, comprising an offset allocation block which allocates, to each traffic channel, one frame offset of N number of frame offsets generated by dividing a predetermined time length T when data is transmitted/received via radio in said predetermined time length frame unit; a radio interface which transmits traffic data at a timing according to the frame offset allocated to said traffic channel when a frame of a predetermined traffic channel is transmitted via radio; and a transmission line interface block which assembles cells using the traffic data of each traffic channel, and transmits/receives the cells to/from the base station controller via the transmission line at timing according to the frame offset allocated to said traffic channel,
wherein said frame offset allocation method comprises the steps of:
tolerating the phase fluctuation of cells on the transmission line for the M frame offset width; and
allocating a same frame offset to a plurality of traffic channels considering the data transmission band determined by said tolerated phase fluctuation width.

9. The frame offset allocation method for a base station transceiver sub-system according to claim 8, wherein the band management range according to said tolerated fluctuation width is set as said data transmission band corresponding to each of said plurality of frame offsets, and each frame offset is allocated to the plurality of traffic channels so as not to exceed said band management range.

10. The frame offset allocation method for a base station transceiver sub-system according to claim 9, wherein it is checked sequentially whether the remaining data transmission band in the band management range of each frame offset is greater than the required band of the traffic channel, and if greater, the frame offset according to said band management range is allocated to said traffic channel.

11. The frame offset allocation method for a base station transceiver sub-system according to claim 10, wherein when said frame offset is allocated to a traffic channel, the remaining data transmission band of the band management range according to said frame offset is decreased, and the remaining data transmission enabled band of the band management range of another frame offset which will be influenced by the allocation of said traffic channel is decreased.

12. The frame offset allocation method for a base station transceiver sub-system according to claim 10, wherein when a traffic channel is disconnected, the remaining data transmission band of the band management range according to a frame offset which is allocated to said traffic channel is increased, and the remaining data transmission band of the band management range of another frame offset which will be influenced by the disconnection of said traffic channel is increased.
